(19) United States
(12) Patent Application Publication
(10) Pub. No.: US 2025/0178944 A1
(43) Pub. Date: Jun. 5, 2025

(54) IMPROVEMENTS IN AND RELATING TO EFFLUENT AND TREATMENT OF SAME

(71) Applicant: Lincoln University, Hamilton (NZ)

(72) Inventors: Hong Jie DI, Hamilton (NZ); Keith Craig CAMERON, Hamilton (NZ)

(21) Appl. No.: 18/843,198

(22) PCT Filed: Feb. 7, 2024
(86) PCT No.: PCT/NZ2024/050009

§ 371 Date: Aug. 30, 2024

(30) Foreign Application Priority Data
Feb. 7, 2023 (AU) 2023200656

(51) Int. Cl. C02F 11/02; B01F 23/45; B01F 25/00; B01F 35/71; B01F 101/00; C02F 1/68; C02F 3/02; C02F 103/20

(52) U.S. Cl. CPC C02F 11/02; B01F 23/45; B01F 25/105; B01F 35/712; B01F 35/7176; C02F 1/686; C02F 3/02; B01F 2101/305; C02F 2103/20; C02F 2209/04

(57) ABSTRACT

The use of polyferric sulphate (PFS) or ferric sulphate (FS); and sulphuric acid (SA); in combination to treat liquid animal effluent and/or sludge (i.e., a combination treatment), to reduce methane emissions from liquid animal effluent and/or sludge (i.e., a combination treatment), compared to untreated liquid animal effluent and/or sludge.

### FIELD OF INVENTION

The present invention relates to improvements in and relating to effluent and treatment of same. In particular, improvements in, and relating to, reducing methane emissions from animal effluent. The present invention may also have utility to simultaneously reduce hydrogen sulphide emissions from effluent.

### BACKGROUND TO THE INVENTION

The present invention will now primarily for ease of reference be described in relation to a dairy farm effluent treatment system. However, it is envisaged the present invention may well have application to other sources of animal effluent so any such discussion should not necessarily be seen as limiting.

Animal effluent storage on dairy farms presents a number of critical problems which include emissions of methane gas (CH₄), which is a powerful greenhouse gas with a 100-year global warming potential 28 times that of carbon dioxide.

There has been an increase in proportion of New Zealand dairy farms using animal effluent storage ponds for manure management; from c. 5% in 1990 to c. 81% in 2017 (MPI 2017). This increase in the use of storage ponds has occurred in order to:
(i) capture and store effluent from off-paddock structures (e.g., milking shed, feed pads, stand-off pads); and
(ii) enable irrigation of the effluent onto land to be deferred until the risk of ponding and/or runoff into rivers and lakes is avoided (commonly called ‘deferred irrigation’).

Regional authorities (regional councils) have been encouraging/requiring dairy farmers to construct effluent ponds that provide a large storage capacity (in some cases up to 3 months of storage) in order to reduce the risk of effluent having to be applied onto land during wet conditions.

However, an ‘unintended consequence’ of increasing the number and size of animal effluent storage ponds is that there is a greater risk of methane emissions contributing to climate change.

Data published in New Zealand's Greenhouse Gas Inventory states that greenhouse gas emissions from Manure Management increased by 121% from 720.7 kt CO₂-e in 1990 to 1,596.8 kt CO₂-e in 2017 (MFE, 2019a).

The vast majority (>90%) of the greenhouse gas emissions from the Manure Management category are in the form of methane gas produced during storage and management of farm dairy effluent. When effluent is stored in ponds, the organic matter in the effluent decomposes anaerobically producing methane gas. In 2017, methane emissions from the manure management contributed 1,475.1 kt CO₂-e; which represents 92.4% of the Manure Management category (MFE, 2019a). The remainder 121.6 kt CO₂-e (7.2%) is nitrous oxide produced by nitrification and denitrification processes (i.e., <8% of the manure management category).

In 2017, Manure Management contributed 4.1% of greenhouse gas emissions from the total New Zealand agricultural sector making it the third largest GHG category after Enteric Fermentation and Agricultural Soils categories. However, since the vast majority of effluent storage ponds are constructed on dairy farms it has been estimated that Manure Management accounts for about 7 to 10% of the methane emissions from dairy farms (MPI, 2012; Laubach et al., 2015).

The New Zealand Ministry for the Environment Interactive GHG Inventory (MFE, 2019a) states that in 2017 the amount of methane emitted from dairy cattle manure ponds was equivalent to 1,255 kt CO₂-e and that dairy cattle enteric fermentation emissions of methane was equivalent to 13,560 kt CO₂-e. Thus, the total amount of methane emitted from New Zealand dairy farms was equivalent to 14,815 kt CO₂-e and 8.5% of this total amount came from manure management (i.e. ponds).

Therefore, it would be useful if an animal effluent treatment system could be devised which could reduce the risk of methane emissions from animal effluent and especially from animal effluent storage ponds or the like.

The inventors have previously devised a treatment using polyferric sulphate (PFS) or ferric sulphate (FS) to significantly reduce methane emissions as detailed in WO 2021/071367 A1.

However, PFS and FS, which have outstanding outcomes, are relatively expensive chemicals, as per the following example:

### Representative Cost Example for PFS or FS as a Sole Treatment Agent for Liquid Animal Effluent

Current PFS or FS cost c.=$1.40/L
Average NZ dairy farm effluent=400 cows×70 L/cow/day×270 days=7,560,000 L pa
PFS rate to mitigate methane emissions=1.56 L/1,000 L FDE (250 mg Fe/L)
Volume required=1.56 L×7,560 m3=11,794 L@$1.40/L=$16,511 pa

There therefore remains a need to reduce the costs associated with methane mitigation in dairy farm effluent ponds and the like, to increase uptake of this new technology and not adversely affect farmers looking to help combat climate change.

Sulphuric acid can be used to treat effluent.

### Representative Cost Example for Sulphuric Acid (SA) as a Sole Treatment Agent for Liquid Animal Effluent

Current SA cost=c. $0.5/L
Average NZ dairy farm effluent=400 cows×70 L/cow/day×270 days=7,560,000 L pa
Equivalent SA dose rate to mitigate methane emissions=1.56 L/1,000 L FDE
Volume required=1.56 L×7,560 m3=11,794 L @ $0.5/L=$5,897 pa

It would also be of further advantage if there could be provided a more cost effective treatment for reducing methane emissions from liquid animal effluent and/or sludge than treatment with PFS or FS alone, or SA alone.

It would also be of advantage if there could be provided a more effective treatment for reducing methane emissions from liquid animal effluent and/or sludge than PFS or FS alone, or SA alone.

It would also be useful if there could be provided alternative methods for reducing methane emissions in effluent ponds or the like.

It would also be an advantage to ensure there is at least no increase in toxic hydrogen sulphide gas emissions such as would occur if sulphuric acid was used on its own to treat the effluent.

It would even furthermore be an advantage if a treatment in addition to reducing methane emissions could also reduce hydrogen sulphide emissions from an effluent pond or the like.

It would also be useful if there could be provided treatment formulation which has a viscosity which enables the treatment to be pumped or poured.

It is an object of the present invention to address the foregoing problems of methane gas and/or hydrogen sulphide emissions or at least to provide the public with a useful choice.

All references, including any patents or patent applications cited in this specification are hereby incorporated by reference. No admission is made that any reference constitutes prior art.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### Definitions

The terms ‘farm dairy effluent (FDE)’ and ‘liquid farm effluent’ and ‘liquid animal effluent’ and ‘effluent’ and ‘dirty water’ and ‘slurry’ all refer to animal urine and faecal matter which has been rinsed from a yard, dairy milking shed, barn, or other animal containment area and contains liquid (i.e., water) as well as solid matter mixed therein.

The term ‘sludge’ as used herein refers to the viscous semi-solid material formed from liquid animal effluent over time which resides at the bottom of effluent ponds or effluent storage tanks or the like.

The terms ‘oxidation-reduction potential’ abbreviated to ‘ORP’ or ‘redox potential’ as used herein refers to the tendency of a chemical species (molecules) in the effluent to gain or lose electrons and is measured in mV. A low redox potential value (e.g., negative mV value) indicates that anaerobic conditions are present and that reactions in the effluent will tend towards the reduction of specific molecules (e.g., ferric iron (Fe³⁺) being reduced to ferrous iron (Fe²⁺) or carbon dioxide (CO₂) being reduced to methane (CH₄)).

The term ‘anaerobic’ as used here refers to the absence of oxygen in the liquid animal effluent to an extent that microbes who are classified as anaerobes are favoured.

The term ‘aerobic’ as used herein refers to the presence of oxygen in the liquid animal effluent to an extent that microbes who are classified as aerobes are favoured.

The term ‘agent’ as used herein refers to an element, compound or mixture thereof, which can be in the form of a powder, crystal, gas, liquid or solute, or a mixture of these forms.

The term ‘concentrated sulphuric acid’ as used herein refers to typically 90% to 98% H₂SO₄ and preferably is c. 96% H₂SO₄ and c. 4% H₂O which is around 18 moles of sulphuric acid per Liter.

The term ‘dilute sulphuric acid’ as used herein refers to sulphuric acid having a concentration of substantially 33%-80%—(i.e. substantially 64% H₂O and 33% H₂SO₄ up to substantially 20% H₂O and 80% H₂SO₄.

The term ‘substantially’ as used herein-unless context requires otherwise-refers to an amount which may differ literally from a stated value or range but is still within a margin of variation as would be accepted by a person skilled in the art, as being workable to achieve the objects of the claimed invention, despite the stated amount (i.e., literal bounds) used in claim. For further clarity being within 1% or 6%-10% of a stated amount in a claim should be seen as achievable unless strict compliance with an amount is seen as being essential to achieve the invention. Thus, any claim of the present invention should be evaluated within the context of this definition, unless data in the specification supports and/or prior art cited requires, a narrower view or more literal view, of the stated amounts recited in a claim.

The terms “PFS/FS” or polyferric sulphate (PFS)/ferric sulphate (FS); as used herein should be understood to respectively mean PFS and/or FS.

### SUMMARY OF THE INVENTION

According to a first aspect of the present invention there is provided the use of:
polyferric sulphate (PFS)/ferric sulphate (FS); and
sulphuric acid (SA);
   in combination to treat liquid animal effluent and/or sludge (i.e. a combination treatment), to reduce methane emissions from liquid animal effluent and/or sludge, compared to untreated liquid animal effluent and/or sludge.

It should be appreciated that whilst the data contained in this specification relates to PFS alone of FS alone, there is nothing preventing a mixture of FS and PFS being used to treat effluent as per the present invention.

Preferably, the use of SA and PFS/FS substantially as described above may have a dose rate that is calculated from the measurement of the oxidation-reduction (redox) potential of the liquid animal effluent and/or sludge.

Preferably, the use of SA and PFS/FS substantially as described above may have the combination treatment added to stored liquid animal effluent after optionally around 50% or more of the liquid animal effluent has been removed from wherever the liquid animal effluent is being held to reduce the amount of polyferric sulphate (PFS) or ferric sulphate (FS), and sulphuric acid (SA) needed for the first treatment of the said effluent and/or sludge.

Preferably, the use of SA and PFS/FS may reduce methane emissions:
from the sludge; and/or
from the liquid animal effluent including any further untreated liquid animal effluent entering the pond over an at least a one-month period;
compared to untreated sludge and/or untreated liquid animal effluent.

Preferably, the use of SA and PFS/FS substantially as described above the combination treatment may be used to raise the redox potential of the liquid animal effluent and/or sludge.

Preferably, redox potential values (also called oxidation reduction potential-ORP values) may be measured using a Thermo pH 6+pH/ORP meter (EUT01X245026W) with a double junction gel filled ORP electrode plastic body 12×90 mm with BNC connector 5 m cable (ECFC7960205B) supplied by Thermo Fisher Scientific NZ Limited. This ORP meter has an accuracy of +/−1 mV. This is how the redox potential values were measured in the Examples detailed in the specification and Figures of the present application. However, it should be appreciated that other ORP probes are available and would be suitable for the present invention.

According to a second aspect of the present invention there is provided the use of combination treatment wherein the redox potential is raised to above 0 mV.

Preferably, the redox potential may be raised to 100 mV.

In general, the liquid animal effluent and/or sludge may be held in:
a pond;
a saucer;
a lagoon;
a tank; or
a storage or transportation vessel.

According to a third aspect of the present invention there is provided the use of a combination treatment substantially as described above wherein the PFS/FS and SA may be:
added separately, either sequentially or simultaneously, to the liquid animal effluent and/or sludge; or
mixed together just prior to adding the LAE and/or sludge.

Preferably, when the PFS/FS and concentrated SA are mixed together this is within substantially 10-20 seconds or within substantially 1 m-5 m of being introduced into the pond or effluent holding area. As the inventors have found that after a period of time the mixture of PSF/FS and SA can become viscous and paste like and/or a solid making it difficult to deliver through a pump and pipe system.

According to a fourth aspect of the present invention there is provided a combination treatment for reducing methane emissions from liquid animal effluent and/or sludge compared to untreated liquid animal effluent and/or untreated sludge the combination treatment comprising:
a sulphuric acid (SA) component; and
a polyferric sulphate (PFS)/ferric sulphate (FS) component.

Preferably, there is provided a combination treatment substantially as described above wherein the ratio of SA component to PFS/FS component may be substantially in the range of 29:71 to 50:50.

Preferably, there is provided a combination treatment substantially as described above wherein the concentration of the PFS/FS may be substantially in the range of 50 mg Fe/L to 100 mg Fe/L.

It should be noted that across all aspects of the present invention as outlined herein the concentration of the PFS/FS may be substantially in the range of 50 mg Fe/L to 100 mg Fe/L.

According to a seventh aspect of the present invention there is provided a method of reducing methane emissions from liquid animal effluent which includes the step of raising the redox potential of liquid animal effluent and/or sludge in a pond from −200 mV or below to greater than 0 mV.

Preferably, the method substantially as described above raises the redox potential of the liquid animal effluent to above 100 mV.

Preferably, the method as described above achieves a reduction of methane emissions of at least substantially 90% compared to untreated liquid animal effluent.

According to an eighth aspect of the present invention there is provided a method of reducing methane emissions comprising the step of adding both:
sulphuric acid (SA); and
polyferric sulphate (PFS)/ferric sulphate (SA);
   to liquid animal effluent and/or sludge.

Preferably, the percentage ratio of SA to PFS/FS in the method, use, combination treatment, all as substantially as described above, is substantially from 29% SA to 50% SA.

According to a ninth aspect of the present invention there is provided the use of:
a) polyferric sulphate (PFS)/ferric sulphate (FS); and
b) sulphuric acid (SA);
   to treat liquid animal effluent and/or sludge for the simultaneous reduction of methane emissions and H₂S from liquid animal effluent and/or sludge compared to untreated liquid animal effluent and/or sludge.

According to a 10^{th} aspect of the present invention there is provided a method of reducing methane emissions and hydrogen sulphide emissions from liquid animal effluent comprising the step of co-administering:
sulphuric acid (SA); and
ferric sulphate (FS)/polyferric sulphate (PFS);
   to said liquid animal effluent and/or sludge.

According to an 11^{th} aspect of the present invention there is provided the alteration of a liquid animal effluent and/or sludge from an anaerobic to an aerobic condition to reduce methane and/or hydrogen sulphide emissions relative to untreated liquid animal effluent and/or sludge by creating an aerobic environment that is hostile to methanogens living on or in the sludge in an effluent pond or other effluent repository.

According to a 12^{th} aspect of the present invention there is provided the use of a combination treatment of:
polyferric sulphate (PFS)/ferric sulphate (FS); and
sulphuric acid (SA);
   to increase the redox potential of liquid animal effluent and/or sludge.

Preferably, there is a use of a combination of PFS/SA and sulphuric acid to increase redox potential substantially as described above wherein the redox potential is raised to above 0 mV.

According to a 13^{th} aspect of the present invention there is provided the use of sulphuric acid and PFS/FS to increase redox potential whilst minimising acidification levels of the effluent and/or sludge to stay at a pH of substantially 4 or above.

According to a 14^{th} aspect of the present invention there is provided the use of a combination of concentrated sulphuric acid (SA) and polyferric sulphate (PFS)/ferric sulphate (FS) to treat liquid animal effluent and wherein the dosage of the SA+PFS/FS combination is substantially 0.468 ml/L of liquid animal effluent and/or sludge and amount delivered is whatever is required to achieve a redox potential above 0 mV.

According to a 15^{th} aspect of the present invention there is provided a method of reducing methane emissions from stored liquid animal effluent and/or sludge compared to untreated liquid animal effluent or untreated sludge which comprises the steps of:
a) deciding on either PFS/FS to add to effluent along with SA to form a treatment;
b) adding and mixing into the liquid animal effluent or sludge with an effective amount of the treatment from step a) to increase the redox potential of the liquid animal effluent/sludge to above 0 mV.

According to a 16^{th} aspect of the present invention there is provided the use of redox potential to determine:
the amount of a dose to initially treat liquid animal effluent or sludge; and/or
whether an initial treatment dose has been effective;
   when treating liquid animal effluent or sludge with a combination treatment of PFS/FS and SA to reduce methane emissions relative to untreated effluent or untreated sludge.

According to a 17^{th} aspect of the present invention there is provided a method of treating the sludge associated with liquid animal effluent being held or stored comprising the step of:
a) treating the liquid animal effluent to increase the redox potential from substantially −200 mV or below to greater than 0 mV.

According to a 18^{th} aspect of the present invention there is provided a treatment mixing apparatus which includes:
a) a first pump adapted to be connectable and dis-connectable to a first conduit in fluid communication, or able to be placed in fluid communication, with an effluent pond or tank;
b) a source of concentrated SA and a second pump associated with a second fluid conduit;
c) a source of polyferric sulphate (PFS)/ferric sulphate (FS) and a third pump with a third fluid conduit:
d) a mixing chamber/manifold including
   an inlet connected to the pump so as to deliver effluent to the chamber/manifold; and
   an outlet port;
wherein said sources of PFS/FS are in fluid communication via respective second and third pumps/conduits with the mixing chamber/manifold so second and third pumps can deliver SA and PFS/FS respectively to the chamber/manifold; and wherein said mixing chamber/manifold is adapted so the outlet port can to be connectable and dis-connectable to a conduit which can deliver treated effluent back to the pond.

Preferably, the chamber/manifold may include an oxidation reduction potential (ORP) sensor and/or a pH sensor which are connected to a suitably programmed PLU which controls operation of the respective pumps.

According to a further aspect of the present invention there is provided a truck or other vehicle which includes a treatment mixing apparatus substantially as described above.

Preferably, there is provided a method, or use, substantially as described above wherein the ratio of SA component to PFS or FS component may be substantially in the range of 29:71 to 50:50.

According to a 19^{th} aspect of the present invention there is provided the use of SA and PFS/FS substantially as described above to reduce methane emissions:
from the sludge; and/or
from the liquid animal effluent including any further untreated liquid animal effluent entering the pond over an at least a one-month period;
   compared to untreated sludge and/or untreated liquid animal effluent.

According to a 20^{th} aspect of the present invention there is provided a composition comprising:
liquid animal effluent and/or sludge;
sulphuric acid and PFS/FS.

Preferably, the composition may have pH of substantially 4.

A composition substantially as described above wherein the redox potential of the composition is substantially above 0 mV.

A composition substantially as described above wherein the redox potential of the composition is substantially from 0 mV to substantially 100 mV.

According to a 21^{st} aspect of the present invention there is provided a composition comprising:
liquid animal effluent and/or sludge;
sulphuric acid and PFS/FS;
   wherein the redox potential of the composition is from substantially 0 mV to substantially 100 mV.

According to a 22^{nd} aspect there is provided a use, method, or combination treatment, substantially as described above wherein the redox potential of the composition is moved from substantially −200 mV to substantially 0 mV up to substantially 100 mV.

According to a 23^{rd} aspect there is provided a treatment composition comprising a mixture of:
dilute sulphuric acid (SA); and
polyferric sulphate (PFS)/ferric sulphate (FS).

Preferably, the mixture of dilute SA and PFS/FS is a 50:50 mixture.

In some embodiments the dilute SA has a substantially 50% concentration.

Preferably, the dilute SA has a substantially 33% concentration.

According to a 24^{th} aspect there is provided a use of a treatment composition substantially as described above for the treatment of liquid animal effluent and/or sludge to reduce methane emissions therefrom compared to untreated liquid animal effluent/sludge.

According to a 25^{th} aspect there is provided a use/method of altering the redox potential of liquid animal effluent using a treatment composition substantially as described above such that the redox potential is substantially 0 mV or above.

According to a 26^{th} aspect of the present invention there is provided a treatment apparatus for treating liquid animal effluent which includes:
a) a source of a treatment composition and a pump associated therewith;
b) a conduit connected to the pump said conduit, in fluid communication, or able to be placed in fluid communication, with an effluent pond or tank.

Further aspects of the technology, which should be considered in all its novel aspects, will become apparent to those skilled in the art upon reading of the following description which provides at least one example of a practical application of the technology.

### BRIEF DESCRIPTION OF THE DRAWINGS

One or more embodiments of the technology will be described below by way of example only, and without intending to be limiting, with reference to the following drawings, in which:

FIG. 1 shows how PFS+concentrated sulphuric acid when both are added to liquid animal effluent are highly effective in reducing the methane flux by over 90% and are more effective than PFS alone over a long period of time (FDE=untreated Farm Dairy Effluent; PFS=effluent treated with PFS at a rate of 250 mg Fe/L FDE; PFS+SA 50=effluent treated with PFS at 50 mg Fe/L FDE (0.31 ml/L) plus sulphuric acid SA at 0.31 ml/L; PFS+SA 75 #1=effluent treated with PFS at a rate of 75 mg Fe/L (0.47 ml/L) plus sulphuric acid at a similar rate of 0.47 ml/L; PFS+SA 75 #2=effluent treated with PFS at a rate of 75 mg Fe/L (0.47 ml/L) plus sulphuric acid at a rate of 0.38 ml/L.

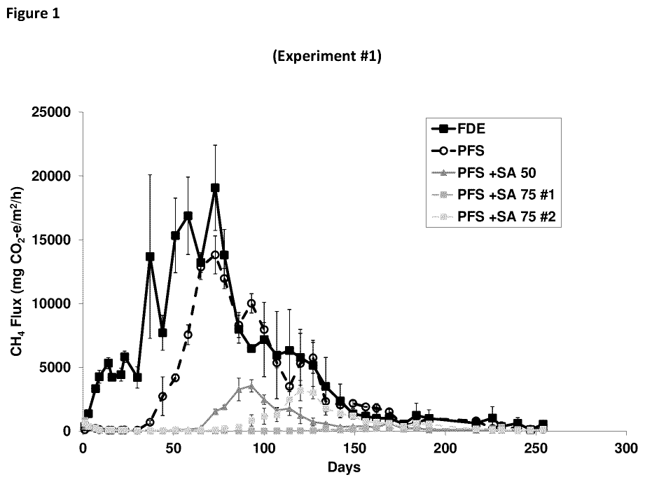

FIG. 2 shows how PFS+concentrated SA when both are added to liquid animal effluent are more effective than PFS alone in raising the initial redox potential of the treated effluent and thus creates an aerobic condition under which the methanogens cannot survive (symbols are as described above).

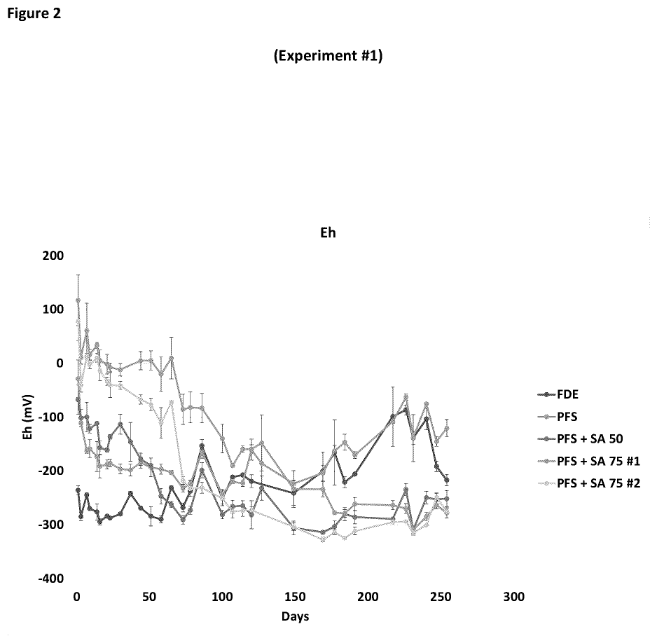

FIG. 3 shows dose response relationships for PFS+concentrated sulphuric acid on pH (symbols are as described above) when both are added to liquid animal effluent.

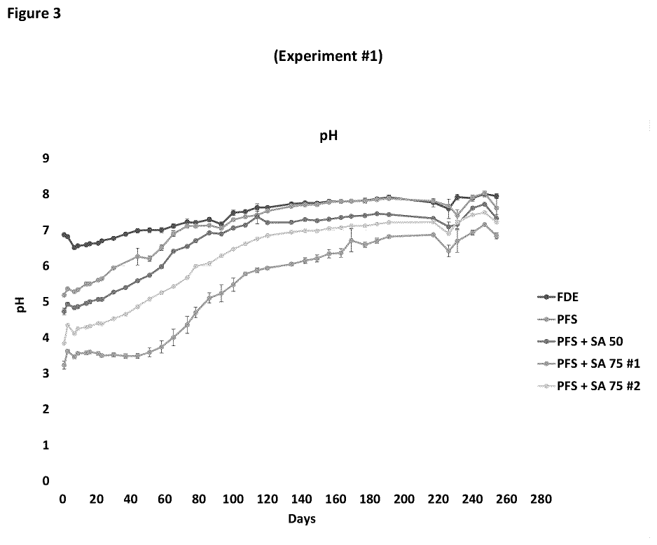

FIG. 4 shows that the concentration of the toxic gas hydrogen sulphide was highest when concentrated sulphuric acid (SA) was used alone to treat the effluent, compared to PFS and/or Ferric Sulphate (FS) used in conjunction with SA (FDE=untreated Farm Dairy Effluent; PFS=effluent treated with PFS at a rate of 225 mg Fe/L FDE (1.4 ml/L FDE); SA=sulphuric acid alone at 0.42 ml/L FDE; PFS/SA 67.5=effluent treated with PFS at 67.5 mg Fe/L FDE (0.4 ml/L) plus sulphuric acid SA at 0.38 ml/L; FS/SA 67.5=effluent treated with Ferric Sulphate (FS) at a rate of 67.5 mg Fe/L (0.5 ml/L) plus sulphuric acid at 0.42 ml/L). The peak hydrogen sulphide gas concentration emitted for the SA alone treatment (41 ppm) is eight times the permissible ‘Time Weighted Average’ (TWA) concentration for an 8-hour working day exposure for this gas (5 ppm) and four times the ‘Short Term Exposure Limit’ (STEL) concentration for 15-minute exposure for this gas (10 ppm), whilst the hydrogen sulphide concentrations for all the other treatments that included PFS or FS along with SA remained below the critical 5 ppm concentration (Reference: https://www.worksafe.govt.nz/topic-and-industry/monitoring/workplace-exposure-standards-and-biological-exposure-indices/all-substances/view/hydrogen-sulphide).

FIG. 5 shows that a dual dose of PFS plus concentrated sulphuric acid is more effective in reducing methane emissions than PFS alone and that the effect lasted for over 2 months-(FDE=untreated Farm Dairy Effluent; PFS 225=effluent treated with PFS at a rate of 225 mg Fe/L FDE (1.4 ml/L FDE); SA=Sulphuric Acid (SA) alone at 0.42 ml/L FDE; PFS/SA 67.5=effluent treated with PFS at 67.5 mg Fe/L FDE (0.4 ml/L) plus sulphuric acid SA at 0.38 ml/L; FS/SA 67.5=effluent treated with Ferric Sulphate (FS) at a rate of 67.5 mg Fe/L (0.5 ml/L) plus sulphuric acid at 0.42 ml/L),

FIG. 6 shows that a dual treatment of FDE with PFS plus concentrated sulphuric acid produced a large and significant reduction of 99% in the total amount of methane emitted from the FDE over a 2-month period. Treatment of FDE with Ferric Sulphate plus sulphuric acid also produced a 99% reduction in the total amount of methane emitted over the 2-month period. Both those treatment mixtures were more effective than PFS alone (61% reduction) or SA alone (96% reduction) (FDE=Farm Dairy Effluent; PFS 225=PFS applied at a rate of 225 mg Fe/L); SA=Sulphuric Acid (SA) alone at 0.42 ml/L FDE; PFS/SA 67.5=effluent treated with PFS at 67.5 mg Fe/L FDE (0.4 ml/L) plus sulphuric acid SA at 0.38 ml/L; FS/SA 67.5=effluent treated with Ferric Sulphate (FS) at a rate of 67.5 mg Fe/L (0.5 ml/L) plus sulphuric acid at 0.42 ml/L).

FIG. 7 shows a strong relationship (R²=0.9943) between the dosage rate of PFS plus sulphuric acid combined treatment of effluent and an exponential decline in methane emission flux with increasing rate of treatment addition. The methane emission flux was reduced by over 99% at treatment rates above 100 mg Fe/L FDE; by 96% at 75 mg Fe/L FDE, and by 91% at 50 mg Fe/L FDE.

FIG. 8 shows that a dual treatment of FDE with the PFS plus sulphuric acid additive at a rate of 0.75 ml PFS/L FDE (c. 150 mg Fe/L) plus 0.3 ml H₂SO₄/L FDE (ratio of sulphuric acid to PFS of 29:71) significantly reduced the methane emission flux from the treated effluent (TE) for 53 days compared to the untreated FDE.

FIG. 9 shows that a dual treatment of FDE with the PFS plus sulphuric acid additive at a rate of 0.75 ml PFS/L FDE (c. 150 mg Fe/L) plus 0.3 ml H₂SO₄/L FDE (ratio of sulphuric acid to PFS of 29:71) significantly reduced the total amount methane emitted from the treated effluent (TE) by 90% compared to the untreated FDE.

FIG. 10 shows that treatment of farm dairy effluent ‘sludge’ from the bottom of an effluent pond with PFS plus sulphuric acid can significantly reduce methane emissions from the ‘sludge’ and from fresh FDE added into the tank for a period of over 85 days (SL U FDE=sludge untreated plus fresh FDE added; SL T FDE=sludge treated with 0.47 ml/L of PFS and 0.47 ml/L of SA.

FIG. 11 shows that treatment of ‘sludge’ from the bottom of an effluent pond with PFS plus sulphuric acid can significantly reduce the total amount of methane emitted from the ‘sludge’ plus fresh FDE added into the sludge by 97%.

FIG. 12 shows a schematic view of a treatment mixing apparatus according to a further aspect of the present invention.

FIG. 13 shows a schematic view of one preferred embodiment of a treatment mixing apparatus as shown in FIG. 12.

FIG. 14 shows a photo of a clear glass bottle containing 50:50 mixture of concentrated SA and PFS.

FIG. 15 shows a photo of a clear glass bottle containing 50:50 mixture of dilute (33%) SA and PFS.

FIG. 16 shows the effectiveness of a new treatment composition comprising a 50:50 mixture of PFS solution and dilute (33%) sulphuric acid in reducing methane emissions.

### DISCUSSION OF DRAWINGS INCLUDING BEST MODES

Further aspects of the present invention will become apparent from the ensuing description which is given by way of example only and with reference to the accompanying drawings.

In the drawings, the units for methane gas emissions are presented in carbon dioxide equivalents because these are the standard units used in New Zealand's national inventory of greenhouse gas emissions (MFE, 2019b) and these units account for the fact that methane has a global warming potential that is 28 times that of carbon dioxide.

Therefore ‘methane emission flux’ (i.e., the mass of methane emitted per unit area per unit time) is expressed in units of ‘mg CO₂-e/m²/h’; and the ‘total amount of methane emitted’ over the measurement period is expressed in units of ‘kg CO₂-e/ha’ (or g CO₂-e/m²).

### Experiment #1

A simulated animal effluent pond column study was conducted to determine the effect of adding a polyferric sulphate (PFS) and various mixtures of PFS plus concentrated sulphuric acid to treat farm dairy effluent collected from a farm. The study consisted of PVC pipes (2000 mm high×150 mm in diameter) with endcaps at the base and detachable gas collection caps at the top of each column. These columns represented the physical dimensions of a column of effluent found in a typical farm dairy effluent pond. There were five treatments: (i) untreated farm dairy effluent (‘Control’), (ii) effluent treated with PFS at 250 mg Fe/L of effluent, (iii) effluent treated with PFS at 50 mg Fe/L plus sulphuric acid at a volume ratio of 50:50, (iv) effluent treated with PFS at 75 mg Fe/L plus sulphuric acid at a volume ration of 50:50, and (v) effluent treated with PFS at 75 mg Fe/L plus sulphuric acid at a volume ratio of 55:45) and three replicate columns for each treatment. Farm dairy effluent was collected from the Lincoln University Dairy Farm and treated as per Table 1 below:

TABLE 1

| | | | | Ratio | |
|---|---|---|---|---|---|
| | | | Per | of | |
| | | PFS | column | SA to | SA |
| | Notes | mls/L | (36 L) | total | mls/L |
| 1 Control | | 0 | 0 | 0 | 0 |
| 2 PFS only | 250 mg Fe/L | 1.56 | 56.16 | 0 | 0 |
| 3 PFS + SA 50 | 50 mg Fe/L | 0.31 | 11.16 | 50% | 0.31 |
| 4 PFS + SA 75#1 | 75 mg Fe/L | 0.47 | 16.92 | 50% | 0.47 |
| 5 PFS + SA 75#2 | 75 mg Fe/L | 0.47 | 16.92 | 45% | 0.38 |

Farm dairy effluent was collected from the Lincoln University Dairy Farm and 36 litres of this effluent was added into each PVC column. The effluent in each column was mixed using a mechanical mixer and the PFS and sulphuric acid was mixed into the effluent according to the treatments listed in the Table above.

Gas sampling was conducted) using a standard procedure for gas sampling (Di et al., 2007). The gas caps were attached to each column and three gas samples were taken with 30-minute intervals between each sampling (i.e. at time=0 mins, time=30 mins and time=60 mins). The gas lids were then removed until the next gas sampling occasion. Gas sampling was conducted at least once per week.

The concentration of CH₄ gas in each sample was determined using a gas chromatograph (GC) (Model 8610C, SRI Instruments, CA, USA) with an automated Gilson GX-271 auto sampler (Gilson Inc., MI, USA) coupled to a flame ionized detector (FID). The GC used three HayeSep D packed pre-columns, and two HayeSep D analytical columns. The carrier gases were H₂ and air and the detector temperature setting was 370° C. Hourly GHG emissions were calculated based on the rate of increase in GHG concentration in the chamber corrected for temperature and the ratio of surface area to headspace volume (Richards et al. 2014). The rate of gas emission was calculated using the slope of headspace gas concentration change from the samples collected on each sampling occasion (Hutchinson & Mosier 1981) and the methane emission flux (i.e. gas emission rate per unit area) was calculated using this data. Cumulative emissions were calculated by integrating the measured daily fluxes for the whole experimental measurement period.

The redox potential and the pH of the liquid in each column was measured immediately after the gas samples had been collected. Redox potential and pH values were measured using a Thermo Fisher Scientific pH 6+pH/ORP meter (EUT01X245026W) with a double junction gel filled ORP electrode plastic body 12×90 mm with BNC connector 1 m cable (ECFC7960205B) supplied by Thermo Fisher Scientific NZ Limited. More information on this ORP meter can be found on the link below:

https://www.thermofisher.com/order/catalog/product/ECFC7960205B

### Experiment #2

The objective of Experiment #2 was to determine the effect of treating effluent with concentrated sulphuric acid (SA) alone versus PFS alone versus mixtures of concentrated SA and PFS versus concentrated SA plus ferric sulphate (FS) on hydrogen sulphide emissions and methane emissions.

This macrocosm experiment used identical 35 L PVC pipes (2.0 m deep×0.15 m diameter) to those used in Experiment #1 and the columns were mounted vertically within a water tank to minimise temperature fluctuations and simulate conditions within a typical 2 m deep effluent pond.

Methane gas concentrations were measured with 30-minute intervals between each sampling (i.e., at time=0 mins, time=30 mins, and time=60 mins). The gas lids were then removed until the next gas measurement occasion. Gas measurement was conducted at least once per week.

Methane gas concentration was measured using gas chromatography (as described in Experiment #1 above).

Hydrogen sulphide gas concentrations were measured after 60 minutes enclosure using a Honeywell BW Max XT II Gas Detector (https://sps.honeywell.com/us/en/products/safety/gas-and-flame-detection/portables/honeywell-bw-max-xt-II#overview).

The treatments consisted of:
FDE=untreated Farm Dairy Effluent;
PFS=effluent treated with PFS at a rate of 225 mg Fe/L FDE (1.4 ml/L FDE);
SA=effluent treated with concentrated Sulphuric Acid (SA) alone at 0.42 ml/L FDE;
PFS/SA 67.5=effluent treated with PFS at 67.5 mg Fe/L FDE (0.4 ml/L) plus concentrated sulphuric acid SA at 0.38 ml/L;
FS/SA 67.5=effluent treated with Ferric Sulphate (FS) at a rate of 67.5 mg Fe/L (0.5 ml/L) plus concentrated sulphuric acid at 0.42 ml/L).

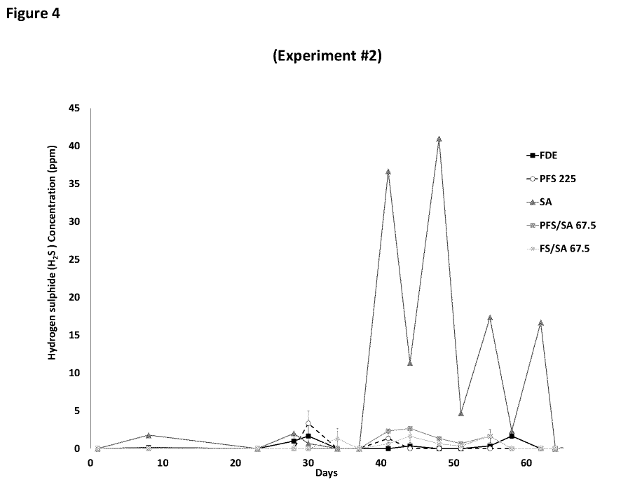

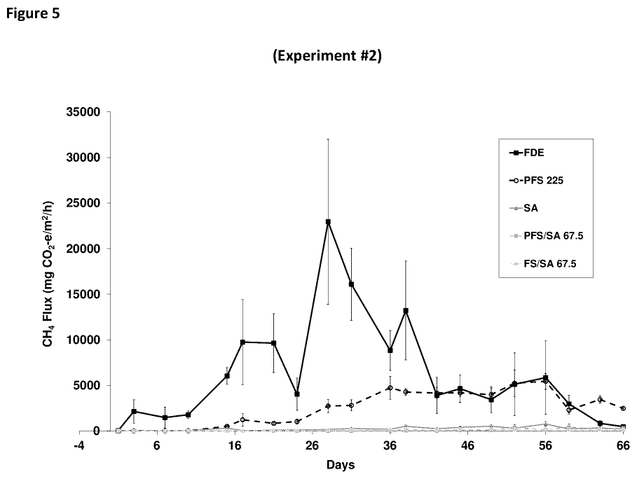

The results in FIGS. 4, 5 and 6, clearly show that the PFS/FS plus sulphuric acid treatments can simultaneously reduce methane and hydrogen sulphide emissions compared to treatment with SA alone.

FIG. 4 shows that the peak hydrogen sulphide gas concentration emitted for the SA alone treatment (41 ppm) is eight times the permissible ‘Time Weighted Average’ (TWA) concentration for an 8-hour working day exposure for this gas (5 ppm); whilst the hydrogen sulphide concentrations remained below the critical 5 ppm level for all the other treatments that included PFS/FS treatment along with the SA treatment.

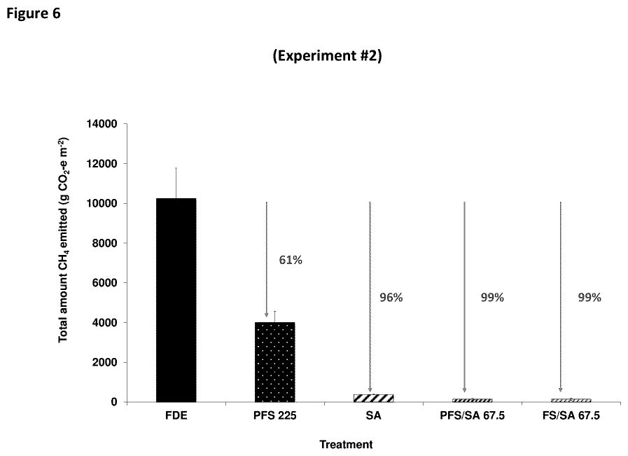

In addition, FIG. 6 shows that the combined treatment of effluent with both SA plus PFS produced the greatest reduction in methane emissions (99%) compared to SA alone (96%) or PFS alone (61%) and that treatment with SA plus FS also produced the greatest reduction in methane emissions (99%) compared to SA alone (96%) or PFS alone (61%).

### Experiment #3

The objective of experiment #3 was to determine the strength of the dose response relationship between rate of SA plus PFS treatment and the methane emission flux.

Experiment #3 was an in vitro experiment conducted using 1 L glass jars with removable lids allowing gas capture and analysis over a 40-day period.

The ratio of SA to PFS added was 33:66 and there were seven rates of addition: 0, 25, 50, 75, 100, 125, 150 mg Fe/L FDE. The gas sampling method and gas analysis method were the same as those described in Experiment #1 above.

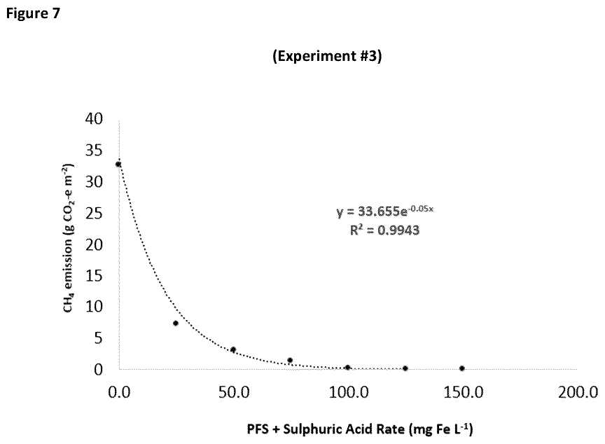

The results are shown in FIG. 7 and depict an exponential decline in methane emissions as the amount of Fe per litre increases up to around 100 mg Fe/L when the curve flattens out.

### Experiment #4

The objective of Experiment #4 was to determine the effectiveness of treating effluent with a different ratio of PFS plus concentrated sulphuric acid to reduce methane emissions from the FDE.

This experiment was conducted using IBC macrocosms on Lincoln University Research Dairy Farm. Each IBC container holds 1000 L to a depth of 1 m and simulates a shallow effluent lagoon or pond.

Each IBC was filled with approximately 950 L of FDE.

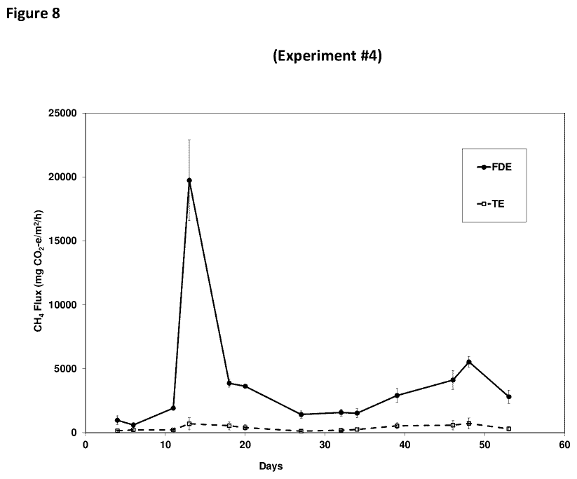

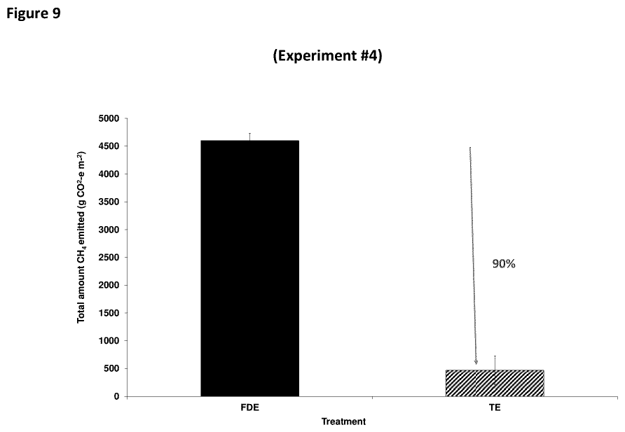

There were two treatments: (i) untreated FDE (labelled FDE FIGS. 8 and 9), (ii) effluent treated with PFS plus sulphuric acid (labelled TE in FIGS. 8 and 9), and three replicates of each treatment.

The treatment consisted of adding 0.3 ml 96% H₂SO₄/L FDE plus 0.75 ml PFS/L FDE (c. 150 mg Fe/L) (ratio of SA to PFS solution was 29:71).

After treatment, each IBC was stirred for two minutes using an electric mixer (including the untreated FDE treatments).

Methane gas concentrations were measured using a tuneable diode laser absorption spectroscopy (TDL-AS) instrument ‘SEM5000’ by Geotech QED Environmental Systems Ltd. The experiment lasted for c. seven weeks.

As can be seen in FIG. 8 the treated effluent (TE) had a significantly reduced methane emission flux over the 53-day measurement period compared to the untreated FDE.

As can be seen in FIG. 9 the treated effluent (TE) that was treated with a SA to PFS ratio of 29:71 resulted in a 90% reduction in the total amount of methane emitted.

### Experiment #5

The objective of Experiment #5 was to determine the effectiveness of ‘shock treatment’ of ‘pond sludge’ to reduce methane emissions from the ‘sludge’ plus untreated FDE subsequently added into the sludge. This experiment is important because animal effluent ponds (and tanks) contain ‘sludge’ on the bottom of the pond (tank) that receives fresh farm dairy effluent daily, and the ‘sludge’ as well as the FDE can emit methane.

Indeed, because of the highly anaerobic conditions at the bottom of a pond/tank there is likely to be a much greater population of methanogens living in and on the ‘sludge’ compared to the relatively small methanogen population in the fresh effluent added into the pond/tank. Therefore, using PFS/FS plus SA to de-activate the methanogens in the ‘sludge’ may be a highly effective way to reduce methane emissions for effluent ponds/tanks.

This experiment was conducted using IBC macrocosms on Lincoln University Research Dairy Farm. Each IBC container holds 1000 L to a depth of 1 m and simulates a shallow effluent lagoon or pond. Each IBC was filled with approximately 200 L of ‘sludge’ collected from the bottom of an effluent pond.

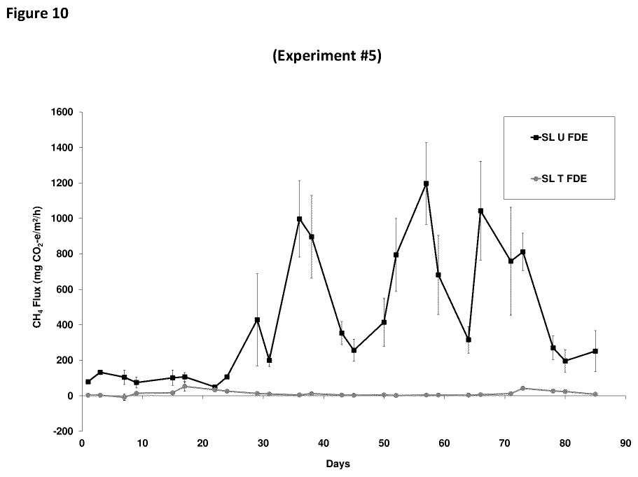

There were two treatments: (i) untreated ‘sludge’ and untreated FDE added twice per week (labelled SL U FDE in FIG. 10), (ii) ‘sludge’ treated with PFS plus sulphuric acid, and untreated FDE added twice per week (labelled SL T FDE), and three replicates of each treatment.

The treatment rate of the concentrated SA+PFS/FS combination tested and labelled SL T FDE was 0.468 ml/L sludge of each treatment additive.

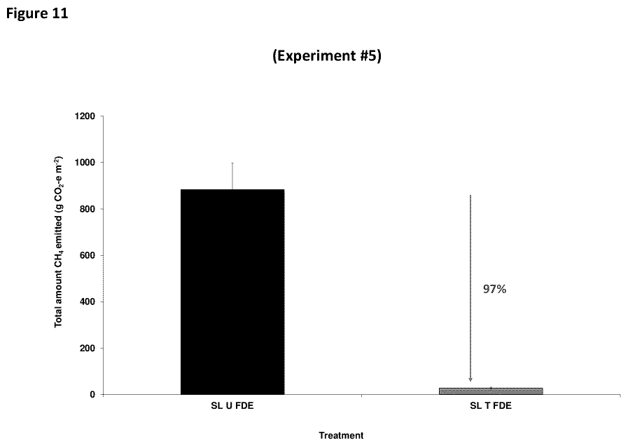

The results from this experiment show that methane emissions were reduced by 97% when the sludge alone was treated (and the fresh input of FDE was not treated) (FIGS. 10 and 11). This is an important discovery in the treatment of animal effluent to reduce methane emissions because the data show that it is possible to reduce methane emissions from an animal effluent pond etc by simply treating the ‘sludge’ remaining in an effluent pond (i.e., once most of the liquid effluent had been pumped out) and not having to treat the fresh effluent entering the pond.

This new discovery opens up the opportunity to use a service tanker type vehicle as one option to deliver the treatment agent(s) directly into the pond and thus removes the need for expensive tanks, pumps, mixing devices, and electronic controls to be installed on a farm to treat the fresh effluent each day.

The cost saving would be substantial with a reduction in Capital Expenditure (Capex) for each farm reduced from c. $60,000 down to less than c. $10,000 (i.e., an 80% reduction in Capex). As can be seen the methane emissions of the treated sludge SL T FDE in FIG. 10 are kept predominantly at, or near, zero over the 90-day period of testing. This long period of effectiveness means that the service truck would only need to visit and treat an effluent pond/tank substantially once every 1 to 3 months (rather than having to treat the fresh effluent entering the pond/tank every day).

### Treatment Mixing Apparatus

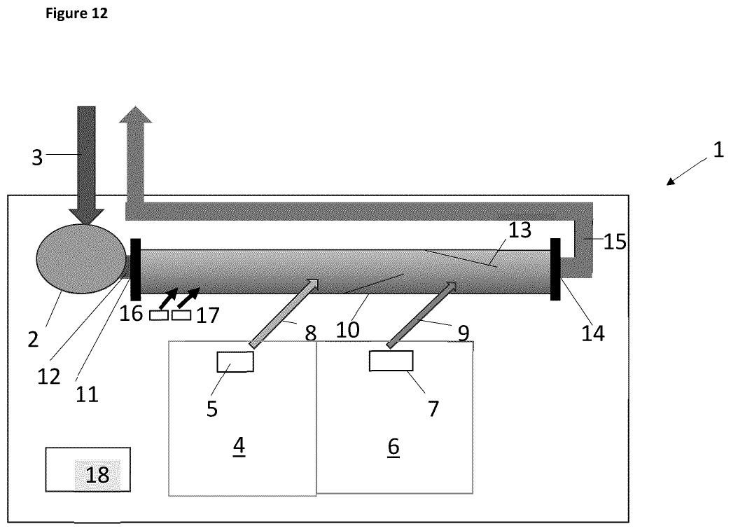

In relation to FIG. 12 there is shown a treatment mixing apparatus (TMA) 1 in accordance with a further aspect of the present invention.

The TMA 1 has a first pump 2 adapted to be connectable and dis-connectable to a conduit 3 in fluid communication, or able to be placed in fluid communication, with an effluent pond (not shown).

The TMA 1 also has a source of SA 4 and a second pump 5 along with a source of PFS or FS 6 and a third pump 7.

The source of SA 4 and associated pump 5 and source of PFS or FS 6 and associated pump 7 are connect to respective conduits 8 and 9 which connect to a mixing chamber/manifold 10.

The mixing chamber/manifold 10 (herein manifold for ease of reference only) has at one end thereof an inlet port 11 connected to a pump 2—via conduit 12—which can in-use deliver effluent to the manifold.

Optionally, the manifold 10 has located therein, a number of vanes 13, which in-use cause turbulence in the fluid flow of the liquid effluent to create mixing. The manifold 10 has an outlet port 14 at the opposite end to the inlet 11. The outlet port 14 is adapted to be releasably connectable to a conduit 15 which can deliver treated effluent back to the pond.

The TMA 1 also has a ORP sensor 16 positioned proximate the inlet port 11 to measure the redox potential of the incoming effluent. The ORP sensor 16 and pumps 2, 5 and 7 all being controlled by a suitably programmed PLC 18. A pH sensor 17 is also positioned proximate inlet port 11 also to measure the acidity of the incoming effluent.

Preferably, the manifold may be adapted to allow for quick fit/removal of the sensors to enable the sensors to be cleaned and recalibrated before each treatment.

The PLC starts the treatment process by turning on pumps 2, 5 and 7 the PLC being programmed to turn off pumps 2, 5 and 7 when either the Eh=+100 mV or until a pH of 4 is achieved via the incoming effluent for a period of substantially 3 minutes to 5 minutes.

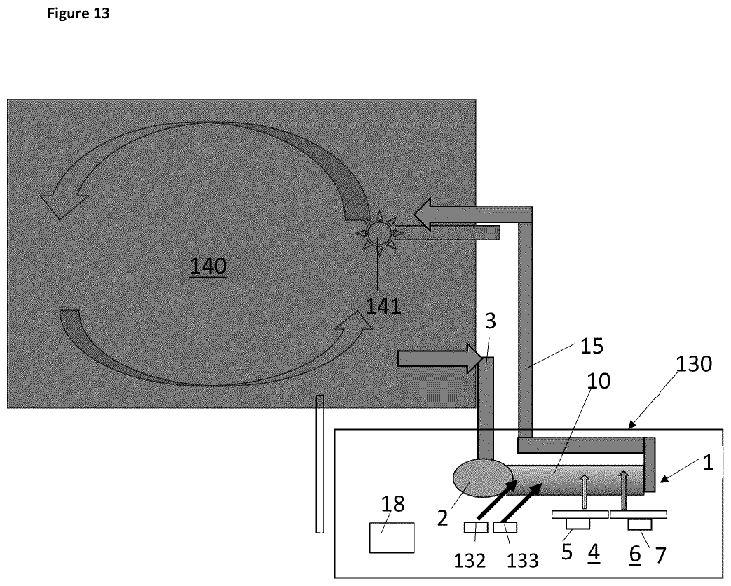

In relation to FIG. 13 there is provided a mixing apparatus 1 which is located on a tanker truck 130 and like elements to FIG. 12 have been given like reference numerals. The mixing apparatus 1 has a PLC 18 which is connected to an ORP sensor 16 and a pH sensor 17 along with the pumps 2, 5 and 7.

The truck 131 connects to flexible conduits 3, 5 which are into fluid communication with an effluent pond 140. Preferably the pond 140 has a conventional mixer 141 used in effluent ponds to assist with mixing the combination treatment into the liquid effluent.

As described earlier in this specification, the use of a of PFS/FS plus sulphuric acid (H₂SO₄) as a dual treatment has been found to simultaneously reduce emissions of the potent greenhouse gas-methane and the toxic gas-hydrogen sulphide (FIG. 13a, b). However, it is not possible to simply combine (i.e. mix) a PFS/FS solution with concentrated sulphuric acid due to the fact that it produces a ‘paste/solid’ that cannot be pumped.

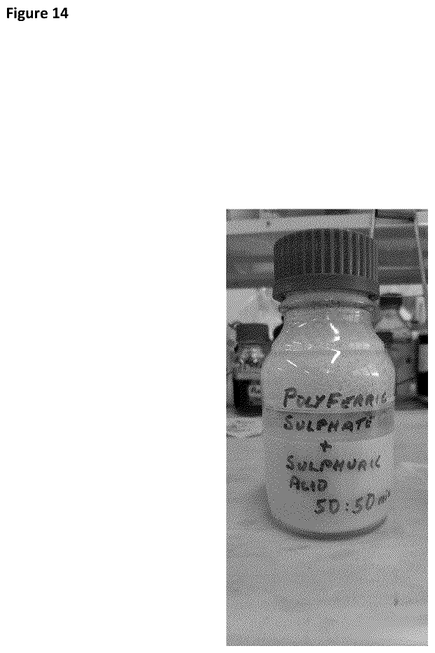

In relation to FIG. 14 it can be seen that the concentrated SA and PFS 50:50 mixture is an opaque milky white paste/solid.

To overcome this limitation the inventors conducted a series of laboratory trials to find a way to combine the PFS solution with sulphuric acid in such a way that the mixture remained as a liquid that can be pumped (and therefore used as a single step additive to treat animal effluent to reduce methane emissions).

The inventors diluted concentrated sulphuric acid by gradually adding it into water in a laboratory beaker that was siting in a ice bath. The ice bath was used because of the exothermic reaction that occurs when concentrated sulphuric acid is added into water. Once cooled, each batch of dilute sulphuric acid was then gradually mixed into a beaker containing the polyferric sulphate. The physical state of the mixture (i.e. liquid or solid) was observed and photographed, as shown in FIG. 14. It was clear from observation when the mixture was liquid or solid. This laboratory work was conducted in a laboratory fume cabinet with the hood down to ensure there was no risk of injury to the staff conducting the experiment.

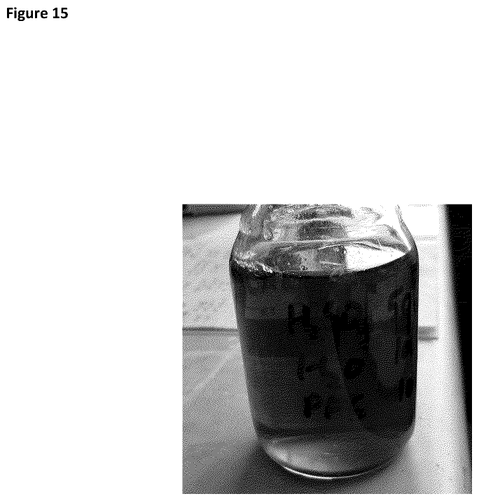

By way of contrast, in FIG. 15 it can be seen that the dilute (33%) SA and PFS 50:50 mixture has produced a translucent reddish-brown liquid which is not viscous (i.e. has a similar viscosity to water) and is pourable/pumpable.

The inventors have discovered that a PFS solution can be combined with a more dilute (33%) solution of sulphuric acid and that the mixture remains in liquid form for over 9 months which is the age of the mixture shown in the photo of FIG. 15.

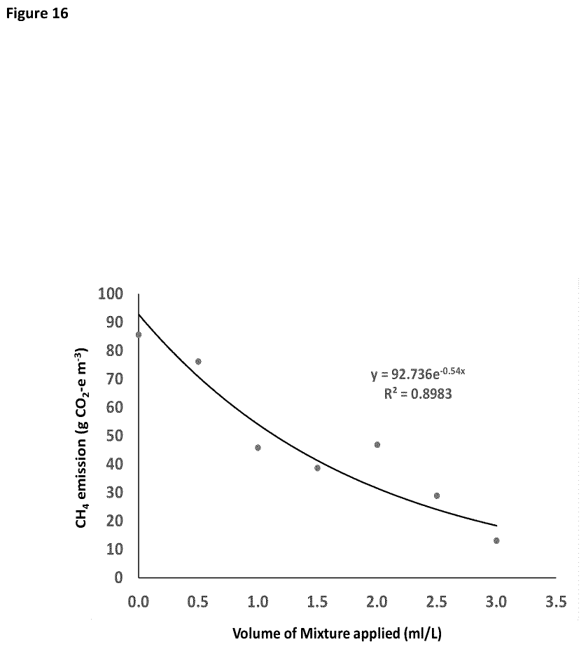

The inventors developed a dose response curve showing the effects of increasing rates of treatment of farm dairy effluent with the dilute SA/PFS mixture on methane gas emissions (FIG. 16).

### FURTHER DETAILED DESCRIPTION INCLUDING FURTHER PREFERRED OR ALTERNATE EMBODIMENTS OF THE INVENTION

The present invention has application to cattle, in particular, including dairy cows but also has application to other agriculturally reared animals (e.g., beef cows, pigs, sheep).

Thus, it should be appreciated, that the present invention can also be broadly applied in relation to other agricultural land-based animals, which when farmed are grouped in areas where liquid effluent is going to be collected and needs to be stored or disposed.

The present invention concerns the surprising discovery that adding both polyferric sulphate plus concentrated sulphuric acid into liquid animal effluent, contrary to what is taught in the art of human municipal wastewater treatment-which by way of stark contrast, wants to reduce the ionic sulphur content in effluent in order to prevent hydrogen sulphide production (HulshoffPol et al., 1998, Metcalf and Eddy, 2014)—can significantly and simultaneously reduce methane emissions and hydrogen sulphide emissions.

It is also important, however, to note that the (human) wastewater treatment engineering literature actually teaches that sulphate can cause the ‘failure’ of the anaerobic process of organic matter digestion used in many wastewater treatment facilities (HulshoffPol et al., 1998, Metcalf and Eddy, 2014)). Therefore, it was totally unexpected that adding polyferric sulphate and sulphuric acid (given the concerns noted above) would be useful to reduce methane emissions and/or hydrogen sulphide emissions from animal effluent.

The main reason that the wastewater treatment plant engineers would not want large amounts of sulphate in the anaerobic treatment plant is that it inhibits the full anaerobic breakdown of organic matter in the sewage water.

The present invention by way of contrast preferably uses polyferric sulphate (or alternately ferric sulphate) plus sulphuric acid to increase the aerobic status (i.e., redox potential) of the effluent and thus prevent the full anaerobic breakdown of the organic matter in order to reduce the production and emission of methane gas.

It is important that the sulphate levels are maintained low in anaerobic treatment of human effluent as the predominant method of disposal of treated human wastewater effluent is to discharge it into surface water (rivers, lakes or the ocean) (e.g., Christchurch City Council, 2019; Brittania, 2019). When treated sewage wastewater eventually goes into rivers, lakes or the ocean, any organic matter remaining in the wastewater will deplete the river, lake, or ocean of oxygen (due to the Biochemical Oxygen Demand (BOD) of the organic material) causing death of fish and other aquatic life (MFE, 2019b). The BOD of the treated effluent must be kept low to avoid adverse impacts on the receiving water (MFE 2019b) thus the anaerobic process must not be inhibited by the presence of sulphate.

Thus, wastewater treatment plants do not want to add sulphates including ferric sulphate or polyferric sulphate to the sewage water.

HulshoffPol et al. (1998) specifically states that the presence of sulphate “can cause severe problems when sulphate containing organic wastewater is treated anaerobically”. This is of the utmost importance, because free hydrogen sulphide (H₂S) concentrations can cause wastewater treatment process failure due to sulphide toxicity.

According to HulshoffPol et al. (1998) gaseous and dissolved sulphides cause physical-chemical (corrosion, odour, increased effluent chemical oxygen demand) or biological (toxicity) constraints, which may lead to process failure.

Therefore, attempts have been made to remove, or suppress, the effects of sulphate in wastewater treatment plants. For example, the strategies currently available to do this include: i) removal of the organic matter, ii) removal of sulphate or iii) removal of both—(HulshofPol et al. 1998).

Zub et al. (2008) also provided a list of strategies to remove sulphur containing compounds from wastewater prior to treatment in order to ensure that the biological process of wastewater treatment is not adversely affected.

Treating animal effluent with polyferric sulphate together with sulphuric acid on a farm is also different to treating sewage wastewater because the treated animal effluent is generally applied onto the land; where there is much less risk of impact in terms of Biochemical Oxygen Demand (BOD) compared with human effluent which is discharged into surface water as discussed earlier.

So, the present invention provides a previously unforeseen opportunity to inhibit the anaerobic breakdown process in animal effluent before methane gas gets produced whilst the human sewage wastewater engineers cannot interfere with the anaerobic process by adding polyferric sulphate let alone sulphuric acid, which is adding sulphate containing compounds rather than removing them.

The addition of both PFS or FS with SA also simultaneously reduces the risk of the toxic gas hydrogen sulphide being emitted compared to the addition of SA alone. This is because the iron in the PFS/FS reacts with the sulphide produced from the SA to form iron sulphide precipitate instead of hydrogen sulphide gas that would otherwise be produced.

The present invention also provides an opportunity to return more carbon to the soil if we inhibit the anaerobic process before it produces methane (i.e., rather than allow the carbon to be lost to the atmosphere as methane causing greenhouse gas emissions). As the treated effluent/sludge has organic matter therein containing a large amount of readily available carbon (in the form of simple organic compounds such as acetic acid) which can be applied to the land. Why lose the carbon into the atmosphere if we can recycle it back into the soil?

In preferred embodiments the redox potential of the effluent/sludge may be the method employed to assess the appropriate dose or to test if the treatment has been effective.

The combination polyferric sulphate or ferric sulphate and concentrated sulphuric acid treatment may be added to the liquid animal effluent either whilst in transit to, or once delivered to an effluent storage area, such as but not limited to:
a pond,
lagoon,
a saucer;
tank,
storage or transportation vessel; or
other storage facility or containment arrangement.

The effluent storage area may include a mixing arrangement to thoroughly disperse the combination treatment throughout the liquid effluent therein.

Alternatively, the effluent storage area may be serviced by an external mixing arrangement which may be permanently or temporarily in fluid communication with the liquid effluent in the effluent storage area.

The present invention shows the surprising result that treating the ‘sludge’ in the bottom of an at least partially empty pond is highly effective in reducing methane emissions from both the ‘sludge’, any remaining liquid effluent as well as highly effective in reducing methane emissions of any fresh liquid effluent subsequently added into the pond or other storage area later.

This reduces the Capex required to reduce methane and hydrogen sulphide emissions from effluent ponds by removing the need for expensive equipment to be installed on a farm.

For example, the treatment agents may be delivered directly into the effluent pond from a vehicle that has tanks of each treatment agent (e.g., as shown conceptually in FIG. 13). Alternatively, a very simple mixing arrangement can be set up with a few pumps and tanks of each treatment agent (e.g., as conceptually shown in FIG. 12).

The source of liquid animal effluent may generally be a cattle yard, or a milking shed/parlour for dairy cows.

However, the source of liquid animal effluent should not be limited and may include one or more of the following:
stock lanes (or stock races);
stock feed pads;
stock housing facilities;
cattle trucks;
sheep trucks;
effluent disposal tanks (e.g. sheep/cattle trucks); and
animal holding pens or yards.

In some preferred embodiments the amount of a dose to initially treat liquid animal effluent and/or sludge may be a standard amount based on the volume of liquid animal effluent and/or sludge to be treated.

In other preferred embodiments the amount of a dose to initially treat liquid animal effluent and/or sludge may be based on achieving a specific redox potential reading (>0 mV) after treatment. The treatment would be successful if the Redox potential was increased above 0 mV because this indicates that aerobic conditions have been produced by the treatment and therefore the obligate anaerobic methanogen population cannot survive or produce methane.

In practice the redox potential is not adjusted above substantially 100 mV as the key objective is to keep the pH so it is not too acidic such as would cause corrosion of the pump being used to direct effluent into the manifold/chamber, or corrosion of other effluent management equipment on a farm.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. A method of treating a liquid animal effluent and/or sludge to reduce methane emissions from the liquid animal effluent and/or sludge, the method comprising:
adding to the liquid animal effluent and/or sludge a combination of:
polyferric sulphate (PFS) or ferric sulphate (FS); and
sulphuric acid (SA);
wherein an amount of methane emissions from the treated liquid animal effluent and/or sludge is reduced, compared to untreated liquid animal effluent and/or sludge.

2. The method as claimed in claim 1, wherein a dose rate is calculated from a measurement of the oxidation-reduction (redox) potential of the liquid animal effluent and/or sludge.

3. The method as claimed in claim 1 wherein the combination is added to stored liquid animal effluent after around 50% or more of the liquid animal effluent has been removed from wherever the liquid animal effluent is being held to reduce an amount of polyferric sulphate (PFS) or ferric sulphate (FS), and sulphuric acid (SA) needed for a first treatment of the liquid animal effluent and/or sludge.

4. The method as claimed in claim 1 wherein the redox potential of the liquid animal effluent and/or sludge is raised.

5. The method as claimed in claim 4 wherein the redox potential is raised to above 0 mV.

6. The method as claimed in claim 4 wherein the redox potential is raised to 100 mV or above.

7. The method as claimed in claim 1, wherein the liquid animal effluent and/or sludge is held in:
a pond;
a saucer;
a lagoon;
a tank; or
a storage or transportation vessel.

8. The method as claimed in claim 1, wherein the PFS or FS and SA are:
added separately, either sequentially or simultaneously, to the liquid animal effluent and/or sludge; or
mixed together just prior to adding the liquid animal effluent and/or sludge.

9. A combination composition comprising:
a sulphuric acid (SA) component; and
a polyferric sulphate (PFS) or ferric sulphate (FS) component.

10. The combination composition as claimed in claim 9, wherein the ratio of SA component to PFS or FS component is substantially in the range of 29:71 to 50:50.

11. A combination composition as claimed in claim 9, wherein a concentration of the PFS or FS is substantially in the range of 50 mg Fe/L to 100 mg Fe/L.

12. The method according to claim 1, wherein the redox potential of liquid animal effluent and/or sludge is raised from −200 mV or below to from 0 mv to 100 mV.

13. (canceled)

14. The method according to claim 1, wherein the reduction of methane emissions is at least substantially 90% compared to untreated liquid animal effluent.

15. (canceled)

16. The method according to claim 1, wherein a percentage ratio of SA to PFS/FS in the mixture is substantially from 29% to 50% SA to PFS/FS.

17. (canceled)

18. The method according to claim 1, wherein methane and H₂S emissions from the liquid animal effluent and/or sludge are simultaneously reduced compared to untreated liquid animal effluent and/or sludge.

19. (canceled)

20. The method according to claim 18, wherein adding the combination creates an aerobic environment that is hostile to methanogens living on or in the liquid animal effluent and/or sludge in an effluent pond or other effluent repository.

21. (canceled)

22. The method as claimed in claim 1, wherein the redox potential of the liquid animal effluent and/or sludge is increased while minimizing acidification levels of the liquid animal effluent and/or sludge to stay at a pH of substantially 4 or above.

23. (canceled)

24. The method according to claim 1, wherein the dosage of the SA+PFS or FS combination is substantially 0.468 ml/L of liquid animal effluent and/or sludge and amount delivered is whatever is required to achieve a redox potential above 0 mV.

25. (canceled)

26. The method of claim 1 comprising using redox potential to determine:
the amount of a dose of the combination to initially treat the liquid animal effluent and/or sludge; and/or
whether an initial treatment dose has been effective.

27. (canceled)

28. A treatment mixing apparatus which includes:
a) a first pump adapted to be connectable and dis-connectable to a conduit in fluid communication, or able to be placed in fluid communication, with an effluent pond or tank;
b) a source of SA and a second pump;
c) a source of polyferric sulphate (PFS) or ferric sulphate (FS) and a third pump:
d) a mixing chamber/manifold including
an inlet connected to the pump so as to deliver effluent to the chamber/manifold; and
an outlet port;
wherein said source of SA and said source of PFS/FS in fluid communication with the mixing chamber/manifold so second and third pumps can deliver SA and PFS respectively to the chamber/manifold; and wherein said mixing chamber/manifold is adapted so the outlet port can to be connectable and dis-connectable to a conduit which can deliver treated effluent back to the pond.

29. The method as claimed in claim 1, wherein an amount of methane emissions from the treated liquid animal effluent and/or sludge is reduced over at least a one-month period.

30. (canceled)

31. A composition as claimed in claim 9, wherein the composition has a pH of substantially 4.

32. A composition as claimed in claim 31 wherein the redox potential of the composition is substantially 0 mV or above.

33. A composition substantially as claimed in claim 32, wherein the redox potential of the composition is substantially from 0 mV to substantially 100 mV.

34. A composition comprising:
liquid animal effluent and/or sludge;
the composition according to claim 9;
wherein the redox potential of the composition is from substantially 0 mV to substantially 100 mV.

35. (canceled)

36. The composition according to claim 9 comprising a mixture of:
dilute sulphuric acid (SA); and
polyferric sulphate (PFS)/ferric sulphate (FS).
